(19) United States
(12) Patent Application Publication
(10) Pub. No.: US 2019/0368758 A1
(43) Pub. Date: Dec. 5, 2019

(54) 4D SYSTEM FOR CONFIGURING, MONITORING AND CONTROLLING CONDITIONS IN A STRUCTURE

(71) Applicant: Innovative Lighting, LLC, Roland, IA (US)

(72) Inventors: Harry Aller, Indianola, IA (US); Rodney Kenneth Edward Barto, Ames, IA (US); Jerrold Handsaker, Roland, IA (US)

(21) Appl. No.: 16/432,600

(22) Filed: Jun. 5, 2019

Related U.S. Application Data
(60) Provisional application No. 62/680,889, filed on Jun. 5, 2018.

(51) Int. Cl. F24F 11/30; F24F 11/52; F24F 11/56; F24F 11/64; F24F 11/65; F24F 11/88; G05B 19/042; H05B 37/02

(52) U.S. Cl. CPC F24F 11/30; F24F 11/52; F24F 11/56; F24F 11/64; F24F 2110/10; F24F 11/88; G05B 19/042; H05B 37/0209; F24F 11/65

(57) ABSTRACT

A coordinated system for a location includes a plurality of sensors arrayed within the location to monitor and record location conditions, and a plurality of interconnected location subsystems for lighting, HVAC, and emergency response. A controller is coupled to the plurality of sensors and to the plurality of interconnected location subsystems. The controller is configured to collect data from the plurality of interconnected location subsystems, collect data from the plurality of sensors, and generate a building information data packet comprising the collected data and a set of building plans in three dimensions.

### BACKGROUND

Lighting Control systems routinely deal with the present status of the lighting within a building. The more advanced systems also gather data to be able to determine the status of the lighting and the amount of energy consumed by the fixtures.

With the advent of networked lighting systems, such as those described in greater detail in commonly owned US Patent publications 2017-0307242, 2017-0321852, and application Ser. No. 15/730,049, the system can be connected with various sensors which can assist in providing information useful in creating functions which enhance the energy savings within the networked lighting system. Such functions include using information from other building sensors, such as, for example, an occupancy sensor, to tell the system that a room is unoccupied, and the lighting should be turned off.

Most of the systems are laid out and commissioned using a two dimensional (2D) representation of the space being illuminated. This space is represented by the XY coordinates. FIG. 1 shows a typical room 100 in a commercial office building. Room 100 may have any number of systems and sensors located therein, in walls, ceilings, and floors, for example. Further, the room 100 has furniture and other fixtures. In room 100, shown in FIG. 1 in 2D representation, the systems and furniture appear overlapping. It is difficult to form a reasonable picture of what the room 100 looks like in reality. For example, in room 100 as shown in FIG. 1, desk 102 is shown, on which a lamp 104, printer 106, and computer 108 sit. However, in a 2D view such as that of FIG. 1, other room elements and components are also shown overlapping with desk 102 and its contents. For example, light fixtures 110 are also shown, two of which overlap desk 102. Sprinkler 112 appears on desk 102. Speakers 114 appear in the vicinity of the desk 102. Additional room elements such as occupancy sensor 115, outlets 116, wall switches 118, window sensors 120, motorized shades 122 with shade sensors 124, door sensors 126, locks 128, water sensor 130, smoke detector 132, camera(s) 134, televisions 136, HVAC vents 138, and HVAC sensors (such as temperature sensor) 140 all appear in the 2D representation of room 100. A view of the room 100 in 2D is difficult to comprehend, especially for a situation to which a first responder may be responding.

Further, in a typical office building space, the systems employed are not coordinated and are not typically collaborative. For example, a lighting system may use lights 110, occupancy sensor 115, and wall switch 118. A fire suppression system may use sprinkler 112, smoke detector 132, and water sensor 130. That system may be tied to, but is not necessarily tied to, door sensor 126 and/or electronic lock 128. HVAC system 138 and sensors 140 are typically a separate system. A security system may include camera 134, window sensors 120, door sensor 126, and electronic lock 128. However, each of these systems are traditionally separate and monitored alone, or at best, in conjunction with other systems.

In an emergency situation, such as a fire, active shooter situation, or the like, time and information are of the essence. However, typical reports of firs or active shooters are done by general alarms or by on-site witness reports. Emergency responders often have little information about the building or location to which they are responding, or the conditions therein.

### SUMMARY

In one embodiment, a coordinated system for a location includes a plurality of sensors arrayed within the location to monitor and record location conditions, and at least one building operation subsystem. A controller is coupled to the plurality of sensors and to the at least one building operation subsystem. The controller is configured to collect data from the at least one building operation subsystem, collect data from the plurality of sensors, and generate a building information data packet comprising the collected data.

In another embodiment, an emergency response method for a building includes collecting data from a plurality of interconnected building systems, and collecting data from a plurality of building sensors. A building information packet is generated, the building information data packet including the collected data and a set of building plans in three dimensions.

In one embodiment, a system includes a fire suppression system, a lighting system, an environmental system. The fire suppression system, the lighting system, and the environmental system are each interconnected. A plurality of sensors for each of the systems records data regarding the systems and conditions within the system, and the data is presentable as a current snapshot of the system.

### BRIEF DESCRIPTION OF THE DRAWINGS

FIG. 1 is a 2D view of a room;

FIG. 2 is a 3D view of a room according to an embodiment of the present disclosure;

FIG. 3 is a virtual representation of a room according to an embodiment of the present disclosure;

FIG. 4 is a virtual rendering a room over time according to an embodiment of the present disclosure;

FIG. 5 is flow chart diagram of a method according to an embodiment of the present disclosure;

FIG. 6 is a view of a building according to an embodiment of the present disclosure; and

FIG. 7 is block diagram of a computer on which embodiments of the present disclosure may be practiced.

### DETAILED DESCRIPTION

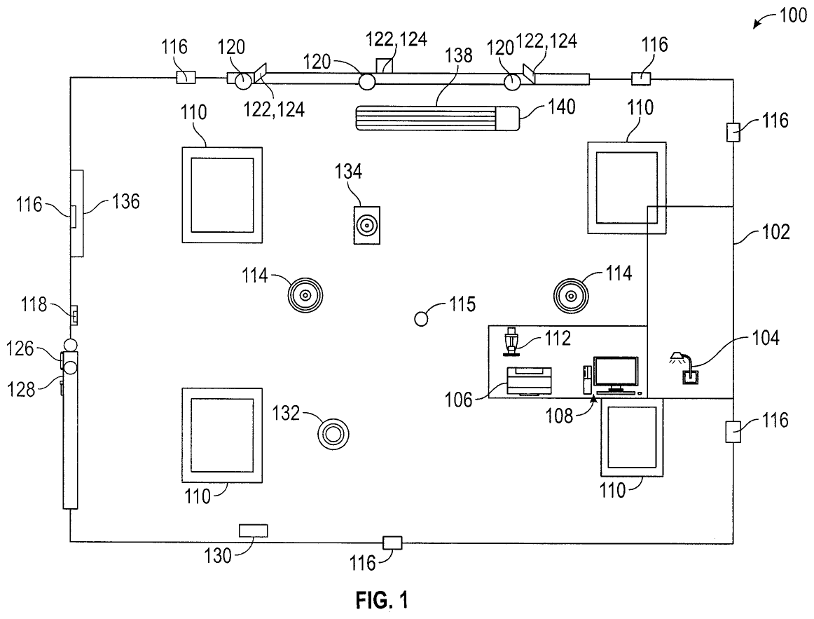

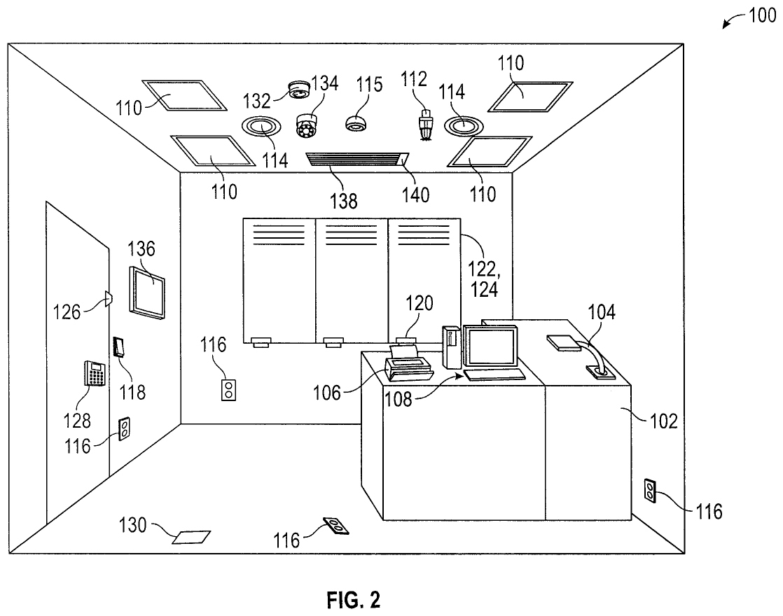

Some of the more advanced systems offer a three-dimensional (3D) representation of the space giving the building manager or other user a greater view of the location and even the area and intensity of the illumination within a space. This space is represented by the XYZ coordinates of the space. FIG. 2 shows the room 100 of FIG. 1 but in a 3D representation. A simple viewing of the 3D representation shows the advantages of 3D rendering. The locations within the 3D space of the room 100 at which components, sensors, and the like are actually present is revealed much more easily than that of room 100 in 2D.

By providing a digital 3D view of the space, together with the locations of the lighting fixtures, devices, and sensors, it is easier to present a useable four-dimensional (4D) view of the space without the delay associated data analytics. A 4D view includes views over time, and may include snapshots of a particular moment in time, or rewinding to find origins of an issue or to determine patterns, and may also involve a predictive look forward based on observed and/or recorded trends. The triggering of a sensor shown in a 3D space or location is quicker and easier to interpret than an activated sensor in a 2D space. When that is then coupled with 4D the picture is complete and immediately useable with many different possible uses.

Embodiments of the present disclosure expand on the concept of lighting systems that are networked together with a number of building systems and sensors, including by way of example occupancy sensors, temperature sensors, air flow sensors, HVAC systems, sprinkler systems, communication systems, emergency systems such as fire alarms, and the like to create a synergy of components that may be used together, along with the data collected by the systems that is stored together. Such coordination allows the use of the coordinated system in ways not previously available, such as those described herein with respect to first responders and the like.

First responders as used in the present application means not only emergency personnel such as police, paramedics/EMTs, and firefighters, but also to the first contact personnel for a sensor or alarm type event. That is, the first responder to an outlying sensor reading may be an internal maintenance person. A first responder may be a “data responder” such as a 911 dispatcher, an internal safety monitor, or the like. A first responder in the scope of the application is one who is the first person to receive a report regarding some sensed anomaly or other outlying sensor reading.

The embodiments of the present disclosure therefore provide a coordinated convergence of traditionally independent systems. This convergence provides distinct advantages for operations and safety within a building or location.

The embodiments of the disclosure provide ways to add and easily access the 4^{th} dimension data within the space. That dimension is time. The embodiments gather information through the lighting/fixture/sensor network from the lighting fixture, devices, and connected sensors supporting that network and record and organize the times events take place. It provides a snap shot of their status based on time. This snap shot is easily accessed using transport controls. These transport controls provide access to past, present and even future status of a space. The past and present involves the replaying of past and present saved events. By adding predictive analysis techniques and artificial intelligence (AI), a highly accurate future status of a space can be revealed. The information provided allows the building operator, permitted staff, and first responder agencies, for example, to instantly obtain that information without the assistance of data analysts. This information is gathered in short data streams which are easy to store. Status reports of the lights, devices and sensors based on the precise data collected, including the time and date of the occurrence, are available on request from any authorized user.

With this information, the building owner or other user can easily see many pieces of data, such as when the last person left the building in the evening. This may be determined not only by occupancy sensors but also with the heat sensors now commonly built into lighting to sense the temperature within a room.

By providing information to public safety personnel over a secure protocol, the data available to the system may be used to reveal the entry point of a late-night intruder and even the pathway the intruder took within the building. Information could be relayed to firemen to provide or assist in finding the location or origin of a fire within a building, and path or direction of a fire, all prior to arriving at the building. This information may be used to alert public safety officials of the location of people within a building and the best method of evacuating those people.

The systems described herein in some embodiments capture and automatically organize the data stream which is emitted by the lighting/safety system and all sensors attached to the system. This organized information is then stored and can be requested by the operator much like rewinding a movie and playing it for a certain point in time. Instead of video, the embodiments of the system rewind and produce organized data. It can tell if the space in a building is being properly used. It can tell if a HVAC system is evenly distributing air.

In another embodiment, the system is able to record and/or report unusual activity in a part of the building to assist law enforcement on how to enter a building effectively in the case of an active shooter situation. Utilizing augmented reality (AR) or virtual reality (VR) headsets, law enforcement personnel or other emergency responders may already have viewed a simulated area of the building while driving to the building and before ever setting foot in the building. While the security cameras of a building may provide some of this information, they are easy to avoid or disable. Embodiments of the present system include an active system of sensors positioned everywhere and providing information about changes in air quality, smoke levels, occupant heat levels, lighting levels and movement. There are a multiple of sensors covering every space, not just one camera. There are too many sensors for an intruder to disengage.

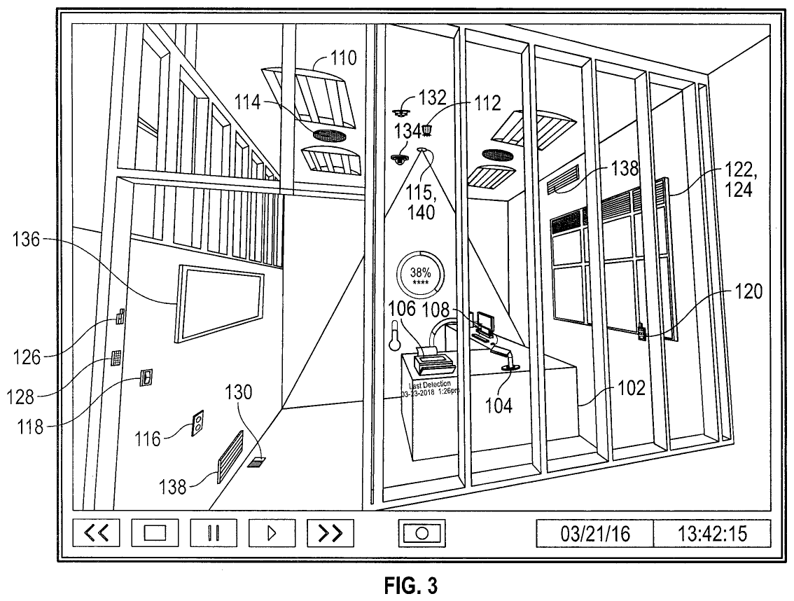

A 3D rendering of room 100 such as may be shown on a computer screen, or using AR or VR headsets, is shown in FIG. 3. 3D rendering places the viewer in a position to see the actual room 100, or a close approximation thereof, and includes in FIG. 3 an immediate snapshot of the room conditions. While not shown, it should be understood that data from any one or more of the sensors in the room may be presented as overlays on the rendering, such as a temperature of the room, sprinkler status, light status, HVAC status, and more. Multifunction sensors identified as 115, 140 may in one embodiment include many different sensors, such as but not limited to motion sensors (occupancy, vacancy), and may be of various types, for example sonic, infrared, etc.; temperature sensors; light level sensors; air quality sensors; and the like. Light fixtures 110 may be individually addressable, dimmable, color changeable, and LED, OLED, MicroLED, or the like. Speakers 114 may be individually addressable, and may include an integrated two-way microphone. TV 136 may be addressable, with integrated camera and/or microphone and speakers. Each of the individual systems is in one embodiment tied, via sensors or the like, into a central hub for the collection of data for the sensors and equipment, to provide a single integrated look at the data of each formerly separate system. The system may have sub-hubs, such as a hub for each room, floor, or other boundary, within a building.

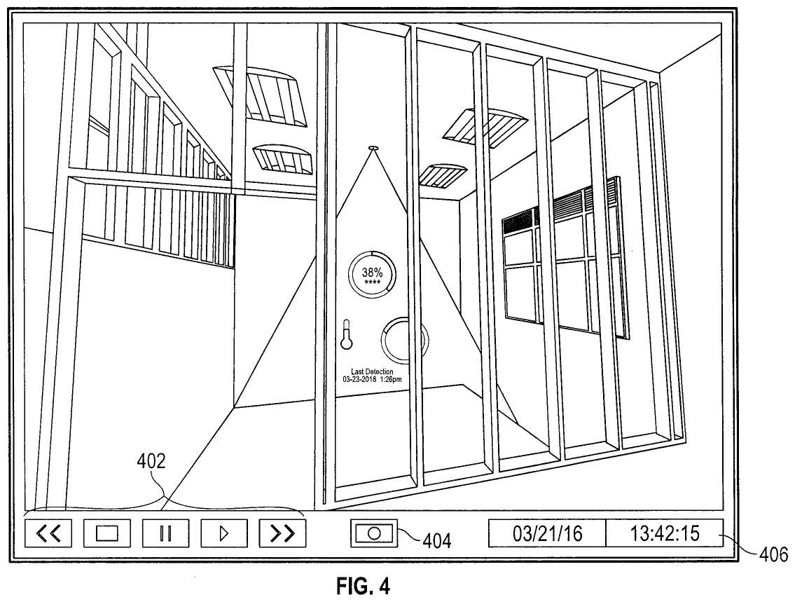

This snapshot ability to view all or a subset of information for room 100 is further enhanced by embodiments of the present disclosure which, using stored data from the sensors and systems within room 100, and for other rooms of a building, present a rendering that can be rewound to show conditions prior to the present time, by displaying data from a previous time within the room. This presentation may be made using the 3D rendering as shown in FIG. 3, but with overlays of data from a particular time, or progressing through a period of time. Further, trends may be shown on the overlays, indicating temperature rises and falls, or the like. FIG. 4 shows a representative view of a virtual rendering which may be rewound, paused, fast-forward, or the like, using “transport” controls 402 (rewind, stop, pause, play, and fast-forward, for example); snapshot display 404, with time stamp data 406. All devices and sensors are connected to the system, which stores their data, and all devices and sensors are able in the virtual rendering to display variables at the specific chosen time, or over a period of time, within the display.

The future of a space can be predicted by Predictive Analysis Techniques and AI elements of the system to allow building owners a vision in how the building will be utilized in the future. For example, knowing past behavior or past operation of heating, lighting, and the like for an entire building allows certain predictions to be made for future use of the same spaces within a building.

All this information easily accessible thru a lighting/control 4D networking system.

Another embodiment of the presently described system includes replacing the familiar transport controls with the ability to enter time-based Queries in relation to a building or a space or portion of space within the building. In either method, the system provides a visualization of the real time status of a space, based on utilizing many sensors, not just sound and video as a camera system would allow. For instance, a user will be able to discern in some cases the smell of the space by the air quality sensor, the temperature using temperature sensors, the air flow using air flow meters within the networked HVAC system, how humid the air is, if a space is occupied in an area not covered by a camera, if a window is locked, and the like. It may sense what is happening in a broom closet, or if there is movement or smoke in a bathroom. Most buildings do not have security cameras in either of those areas.

Embodiments of the system allow all sensors to work in unison to give the inquirer a snapshot view of a moment in time within the interior or exterior of a space. The embodiments further allow the streaming of that information, so the inquirer can then view what was happening to the area in question in the past, such as in the time leading up to an event, or the like.

Embodiments of the system allow first responders and public safety personnel to be better prepared to access a building, to save lives, and to confront danger. They provide a building owner better information to determine how the building is utilized and how to reduce the carbon footprint of the building. They allow tenants better information through which to determine if employees are properly serving customers, manning the company equipment, minimizing waste and scrap, and timely closing the business at the end of the day.

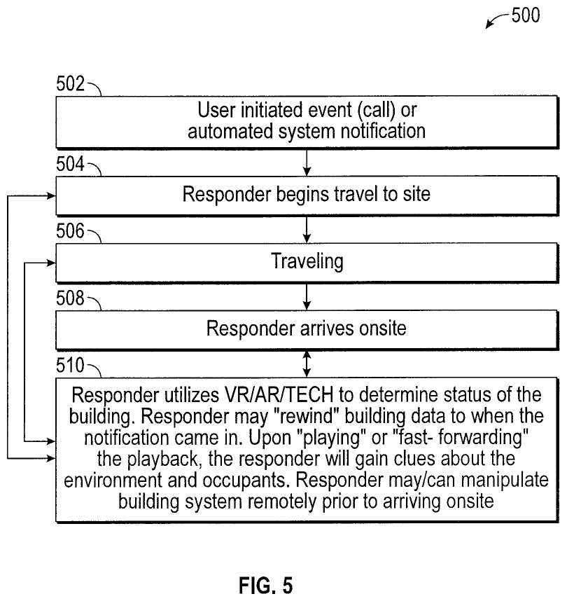

FIG. 5 is a flow chart view of one embodiment 500 of an emergency response set of actions in accordance with an embodiment of the present disclosure. In block 502, an event is initiated. This may be a user-initiated event, or an automated event initiation. In block 504, first responders begin traveling to the site of the event. Traveling to the site occurs at block 506. During traveling, or even before beginning travel to the site, the system authorizes access by first responders to data available to the system, with some actions available to first responders shown at 510. When first responders arrive at the site in block 508, they may have already been able to perform certain actions using the system to control devices and the like at the site, and been able to view renderings of the site to prepare for appropriate response to the event. Further detail of such possible responses and uses of the system are discussed below.

### Focusing on Emergency Situations

1) As sensors become better at detecting potentially dangerous situations, there will be more warnings emitted from the new level of sensitive sensor. For example, even if no fire has yet broken out, but a low-level smoldering situation predicts the fire, action may be taken. The predictions of the embodiments of the system may be of that event maybe hours into the future. If there is only one level of alarm built into a smoke detector, then the fire alarm is activated, and the fire department is on the way. This could result in an unnecessary waste of resources. By networking the smoke detectors to other devices and sensors, such as temperature sensors, air-quality sensors, and the like, an alarm could suggest the level of the danger. Or if the sensors within an area of an activated smoke alarm automatically each report their activity to the fire department, the first responder dispatcher can evaluate the situation and gauge the appropriate response. This may call for a new classification of the normal dispatcher position to add IT capabilities to the role.

2) In some embodiments, the new level dispatcher can manipulate building safety protocol to use the building systems to help reduce an emergency while actual first responders are in route to the building. For instance, if there is a fire alarm activated in a 20-story building, normal protocol would be to release the fire doors, turn off electricity and lighting, and stop the elevators. If the dispatcher/IT can replay the triggering sensor and all sensors in the area and learn that the fire is likely contained in a room on the 10^{th} floor in an opposite end of the building from the elevators, the dispatcher could activate the elevators, lighting, etc. and allow more people to evacuate the building even before emergency personnel arrive on scene.

3) With the 4D aspects of the embodiments of the system, if any unusual event, or series of events, are recorded, and an alarm is required, the system can automatically isolate the events from all sensors in the area and have them organized to play for the first responder under their secure protocol. This degree of automation can help track, locate and neutralize an unwanted intruder in the fastest and safest manner possible.

4) With a trained IT/Dispatcher, the building systems can be used to slow an event causing an emergency. For example, an authorized user such as the dispatcher could cause the building system to evacuate toxic air, shut down ventilation systems to prevent interior distribution of toxic air, route occupants to the safest escape routes, locate incapacitated occupants, provide verbal directions to occupants, operate sprinklers not yet activated by heat but to wet and slow the advancement of the fire traveling in that direction, provide fresh air to the occupants along the escape path while limiting and air to the areas of the fire, sequence the lighting to aid in identifying the correct evacuation route, etc. The possibilities for improving emergency response are limited only by the sensors and operation by a trained emergency responder/dispatcher.

5) Further detail of system embodiments regarding fire suppression to enhance a typical water sprinkler system are provided below. Typically, the standard sprinkler system is a system of water pipes in the ceilings of buildings with deployed sprinkler heads incorporated into the system to commence showering a fire with water if triggered to do so. These sprinkler heads are dispersed along the water supply pipe according to a design to give a set amount of coverage should the sprinkler head be triggered into action. The triggering action is typically the application of significant heat to the sprinkler head, enough to melt a plastic rod or fuse and allow the valve to open. The temperature required to melt the fuse is when the heat on the sprinkler head exceeds 135 degrees. The system is primarily a manual system requiring the heat to operate and normally cannot be remotely operated.

The second function of the system is to activate a fire alarm if a flow valve located near the beginning of the system detects that water has started flowing in the system. This alarm is typically silent as to what sprinkler head has been activated, as the sprinkler system only monitors system flow and not individual sprinkler heads. The system only know that water is flowing somewhere in the building. It could be anywhere in the building. The alarm only knows that somewhere in the building the water is flowing from the building-wide sprinkler system. However, using embodiments of the present disclosure, a network lighting/sensor system within the building is provided with, for example, inexpensive sensors on each of the sprinkler heads or the piping next to the sprinkler head, or to a section of the building covered by a few sprinkler heads. Use of such distributed sensors allows the system to determine where the sprinkler heads are triggered. These alerts would alert the system and the first responders just where the active sprinkler head is located within the building. The first responder could then gauge the size of the fire by activating other sensors in the area of the triggered sprinkler head. A dispatcher or other fire personnel could even learn that there was activity in the area of the sprinkler head, such as a maintenance person accidently striking the sprinkler head with a broom and that the other sensors reveal no heat involved.

6) Whether the sensor system is included either within the sprinkler head or as a separate incorporated device, a remotely controllable valve may be provided. This remotely controllable valve, or multiple valves, may be operated under a special first responder protocol which can release water onto a fire through remote control to either slow the progress of the fire or provide a safe route for otherwise trapped occupants to more safely evacuate the building. The networked sensors may also provide the visibility necessary to help decide where to open the intended valves to release water prior to the heat getting intense enough to otherwise activate the sprinkler head valve along an egress path or the like. The sensors and valve controls could be responding to data provided from wired or wireless sensors. It just requires that the data becomes part of the system and can thereby add to the snap shot of the status of that part of the building at any specific time.

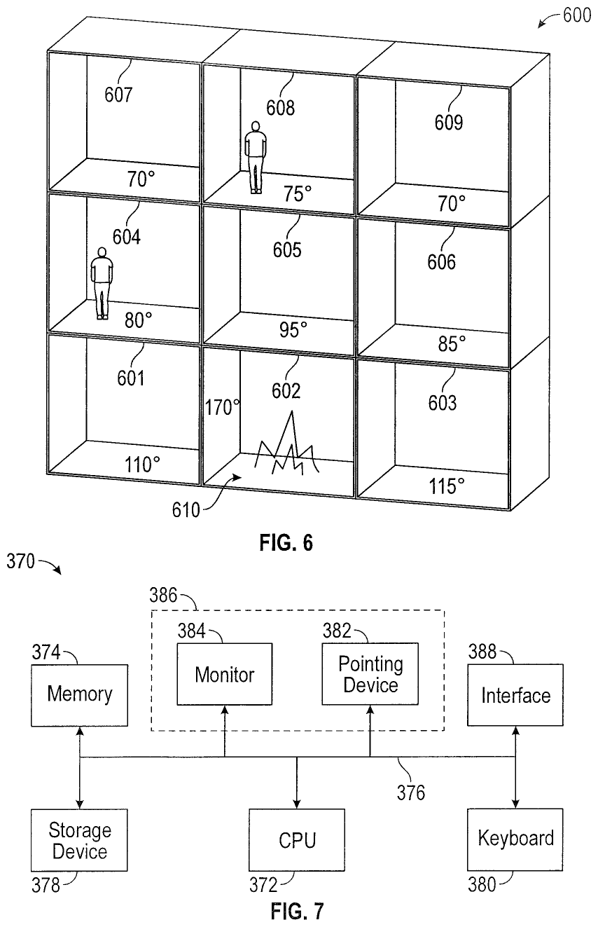

FIG. 6 is a representation of a building 600 having nine rooms 601-609 on three floors. In the representation shown in FIG. 6, a fire 610 has broken out in room 602 on the first floor. Typical deployment of sprinkler systems rely on heat within a space to trigger the release of water (or other fire suppressant). Through the use of controlled valves and/or trigger devices, connected to the systems as described herein, the system may be used to release water (or other suppressant) on demand.

For example, a user of the systems described herein may view a representation such as that shown in FIG. 6 to see that the room 602 is at 170 degrees, whereas surrounding rooms are at lower temperatures. based on the temperature, at this point, it is likely that the sprinkler head in room 602 is operating. While other rooms surrounding room 602 are heating up, they are not yet at temperatures typically sufficient to trigger a sprinkler head to operate. Using the systems embodied in the present disclosure, a first responder, or other user, can remotely activate sprinklers in rooms 601, 603, and 605, for example, to reduce the chances of fire spreading.

Further, occupancy sensors connected to the system indicate that rooms 604 and 608 are occupied. Further room sprinklers may be activated to improve possible escape routes within the building 600. Predictive methods may be used to anticipate, based on empiric or actual evidence of fire spreading likelihoods, to counter possible fire spreading with the application of water from sprinklers based on the predictions.

### Non-Emergency Features of Embodiments of the Present Disclosure are Described Below.

1) System testing and verifications: Many of the systems deployed within a building require or should require periodic checks to see if the systems are performing as required or planned. When networked sensors are automated they can gather the requested information and play such information back to the maintenance personal or building system inspector. It can schedule certain testing protocols and check if the system performs correctly. An example would be if the line power to an emergency light is turned off according to a schedule and the system checked the lighting output of the battery powered light and if that output continued at the required level for the required amount of time. The results could be organized in a report to confirm the testing and results are performed at the required intervals of time.

2) The ability to select areas to review and the time to review provides a great troubleshooting tool for building maintenance. This system gives great vision to unusual events that took place and possibly caused an error alarm or item failure to take place. It may involve the operation of almost any system within the building, not just the lighting system. Because of the ease of scheduling, the systems could routinely and automatically check the HVAC system to insure the comfort of the occupants even though not formally required by a building code. The sensors could check temperature, ability of the air conditioning to cool a space and provide sufficient air flow. It could verify If the activated day light harvesting system is performing accurately and if the power shades are working. The building maintenance personnel can playback the room activity over the past week to verify an occupant's complaint that their temperature periodically spikes. The user may learn the cause of the spikes from the information coming from the sensor activity at the time of the irregularity.

3) A business owner can learn the work habits of the employees. Which employees work through collaboration and which work totally independently and need more isolation. A user could learn what areas of the building a guest visited and when the visitor exited the building. The system of sensors could tell if all employees and guests have left the building prior to locking up for the night, weekend, or holiday. The owner could watch if reducing lighting levels and hence energy use correlates to lowered productivity.

Use of sensors within a building allows many different possible operations to effect egress from the building, fire suppression, and the like, all while a first responder is en route to the scene. For example, occupancy data permits a user (such as a first responder) to identify where people may be in the building. Utilizing individual addressability of light fixtures and the like, a first responder can create a customized sequence of lights (i.e., a sequence of flashing lights) that directs people in the building towards a nearest safe exit. A path created by a first responder may be determined using all information available, such as triggered sprinkler heads, temperature sensors, environmental sensors, and the like.

A responder may override elevator safety protocols in certain situations, such as when reviewed sensor data reveals that an elevator in question is in fact safe. A responder can verify sprinkler operation using flow meters addressable to sections or individual sprinkler heads. The responder may engage additional sprinkler heads, as discussed, where appropriate to contain fires or to wet potential egress areas.

A responder may use environmental sensor data, along with occupancy data, to determine whether the HVAC system of the building may be used to assist in operations to get persons out of the building. For example, an occupant is detected or seen, or phones in. If a sensor indicates smoke levels rising in the area where the occupant is, the HVAC system may be controlled to move fresh air into the room, or to exhaust foul air from the room. HVAC vents away from where personnel are may be engaged to draw smoke or contaminants away from areas where occupants are. In a medical emergency, if available, a responder may increase oxygen levels in a room if viable.

In another example, a responder may trigger a light mode in which occupancy status, as it is known, is shown upon arrival to the site. For example, rooms with known occupancy can be lit to show through exterior windows, for example.

Televisions and/or speakers, as discussed above, may be used to provide 2-way communication between an occupant and a first responder. The responder can even show customized potential escape plans to occupants to avoid areas of known danger. A responder can use cameras in various locations to verify occupancy and condition of occupants.

It should be understood that the embodiments of the present disclosure provide networked sensors for lighting, security, fire, sprinklers, occupancy, temperature, air quality, and the like, but that additional sensors may be utilized and networked into the system without departing from the scope of the disclosure. One of skill in the art would recognize the ways that additional sensors for additional conditions and events could be incorporated into the system.

Embodiments of the present disclosure use and configure the variety of sensors and systems such as those described above to generate a representation of a building or other space that includes connected sensors all feeding information to a central system. The central system maintains sensor data for the interconnected system in one embodiment. The systems of a building or location such as those described above include, in one embodiment, interconnected combinations of sensors, lights, HVAC, fire alarms, sprinklers, and the like. Sensors provide advantages because sensors can be placed in positions where cameras may not reach or be amenable. Sensors therefore can in some embodiments provide information that cameras cannot.

Such interconnected components and their associated data includes the ability to look at a whole building or portion of a building as a whole, with data from the systems. The storage of data allows for an instantaneous look at the system or location as a whole, with the ability to look back in time for precursor events or the like. The amalgamation of data also allows predictions to be made based on past events. This also includes progression of, in one embodiment, conditions that led to an alarm or alert from one or a combination of sensors.

Looks back at prior data provide advantages of troubleshooting, security, and origins of events, for example, Present representation of data provides advantages of monitoring an ongoing situation or current operations of systems, for example. Predictive elements of embodiments of the present disclosure helps in planning for the future of a space, or for something such as increasing temperature in an office prior to the expected arrival of an occupant, or shutting off lights and/or HVAC when a space that was previously occupied is now empty.

Sensors in some embodiments of the present disclosure include by way of example only and not by way of limitation, temperature, motion, air flow, lighting, occupancy, etc. Some sensors in a system such as those described may also in some embodiments be connected not only to sense ambient conditions in a location, but also are connected in some embodiments to external entities, such as a utility or the like. Such sensors that are connected to an external entity such as a utility also serve to monitor the utility, and may alert the utility to a potential problem so that the utility can proactively dispatch a technician to a site before the site may not even be aware of a problem. While the embodiments of the present disclosure are discussed largely in terms of power over Ethernet (POE), it should be understood that other secure types of connections may be employed without departing from the scope of the disclosure. POE and other “closed circuit” types of systems require physical access in order to compromise, and are therefore less susceptible to hacking. Therefore, there is a level of increased security with POE and other closed circuit types of systems over wireless systems.

There is a further benefit from monitoring sensors, because monitoring sensors, or sensing sensors, allows validation when, for example, power and value of a sensor is monitored and checked against historical values, values of sensors near the sensor being monitored, and the like. A determination of validity of a sensor can make the difference between an alarm, or a work review order. For example, a sensor drawing more power than typical could indicate that the sensor is malfunctioning, or could indicate operation under duress. By monitoring the sensor, and other sensors in the vicinity thereof, a determination can be more likely to be correct.

Still further, sensors that are connected to a utility or other external entity also provide a proxy for monitoring the utility or external entity.

Advantages of the representation of connected sensors and the interconnectivity of sensors within a network and to external entities include cost savings, adjustability, lower power consumption, increased data points, and increased ability to predict future events. Saving data points also allows use of transport controls to better view a picture at a point in time, or an evolving picture. For example, upon an alarm or other outlying sensor reading or readings, data for that sensor or for the room/building/location at which the sensor is located may be rewound, viewed at a post point in time, or the like.

Trigger events on sensors or groups of sensors may also be used for a determination that a maintenance operation should be performed, without triggering a full alarm. Full escalation of an alarm to traditional first responders may not be the first action in a network of connected sensors.

To a first responder, of any sort, data about the situation to which the responder is entering is important. For a traditional first responder, for example, the scope of a problem or situation, a list or set of locations of occupants in the building or location, the severity of the situation, may all be provided by a set of sensors, interior cameras, and the like, within a location that uses embodiments of the present disclosure. Not all triggered events require an immediate response. A larger than normal power draw on a sensor may alert a building engineer. A cascading set of failures may escalate to a facilities manager or fire/police/EMT.

Sensing an escalation of an event is consistent with applications of embodiments of the present disclosure. If one temperature sensor indicates a high temperature, a check is made in one embodiment for temperature information for nearby sensors. If the high temperature sensor is the only one, one level of response is indicated. If multiple sensors in the vicinity shown anomalous readings, that may indicate a heightened level of response. Further, sensor data may be combined with environmental conditions to provide a broader picture of a situation.

Secondary, tertiary, etc. notifications may be made by readings and conditions for monitored sensors. This may all be doing automatically according to, in one embodiment, a predefined set of rules.

As has been mentioned, information to an external responder can be critical in executing a plan for when actual arrival occurs. Using embodiments of the present disclosure, external and internal responders are provided with a much clearer picture of the situation to which they are responding. For example, upon a notification from a sensor or sensors, or the indication of an alarm or the like, the type of alarm or situation in one embodiment dictates a certain sequence of events, in many cases absent any human decision. Instead, when data is verified through sensor checks, that is, sensing of the sensors, the valid and verified data may be used by incoming responders in any number of ways.

Once external responders are notified, in one embodiment, all available data for the location may be transmitted or made available to the external responders, such as by providing a data dump to a data responder such as a dispatcher or the like. Then, depending upon the type of response requested or needed, the data responder may request specific subsets of data, such as, for example only and not by way of limitation, a fire subset, a police incident subset, an EMT subset, or the like.

Embodiments of the present disclosure not only allow for external responders to have data about the present situation at the location to which they are responding, some embodiments allow the ceding of control of building/location systems to the external responders. with verified data that is updateable in real time, and which allows transport control functions such as rewind, and predictive functions such as looking forward to a predicted future time, external responders may be able to set or vary protocols. For example, in a six story building, a fire is burning in a north corner of the building on the fourth floor. Building sensors, such as occupancy sensors, temperature sensors, and the like, indicate conditions in the area of a south side elevator. Operation of the elevator, which is normally shut down in the event of fire, may be overridden by incoming emergency responders to leave an unaffected elevator operational. Further, with control of building systems and sensors, inbound responders may notify building occupants, via use of speakers and/or lighting and/or alarm systems within the building, what routes and egress options are available to them in real time.

The remote control of technology within a building being given to incoming responders allows a broad picture of what is happening within a building/location, and allows those responders to take positive action before even arriving on the scene. Quick action has the potential to save many lives. Still further, whereas many fire response systems, such as sprinkler heads, are traditionally activated by heat in the vicinity, and inbound responder with control over systems within a building may activate sprinklers ahead of when they would otherwise be activated, or allows responders to direct air flow into or out of a room, rooms, or section of a building, to allow for control of a fire or the like.

With automatic door locks and the like, a police inbound responder may use occupant location, and sensor data or cameras, to isolate and even contain a threatening situation, such as an active shooter or the like, by arming and disarming certain doors within the location.

The data available to first responders is limited only by the pack of sensors and controls within the building/location. A building definition package, including floor plans, schematics, sensor packs, two- and three-dimensional models, occupancy data, and the like may all be included in a first responder data dump, and filters and active control ceded to inbound responders. Data is in one embodiment provided in a standard format, or in a predefined format, such that incoming responders will be able to see and use the data.

Still further, embodiments of the present disclosure allow responders to don virtual reality or augmented reality sets, or heads up displays, to allow a walk-through of a building, or even a look at a real-time situation as it happens, while still off site. In one embodiment, first responders or safety personal wearing virtual reality, augmented reality or heads up displays onsite are able to view sensor status and/or building conditions while walking through the building. In essence, using the current data from building systems and sensors, responders can use an overlay virtual or augmented reality display with real-time data while in the building. For example, a responder may have information on the VR/AR/heads up display regarding occupants within a room or area, or the temperature of the room or area, right in his or her sight line in real-time. Such information may be displayed, for example, on a wall of a room, so that a responder need not even enter the room to have an accurate picture of what is inside the room.

Such VR and AR opportunities allow a collaborative effort among data responders, external responders (emergency/utility/etc.), and on site responders. Collaborative action among all such responders provide early awareness and a more complete picture of a building/location, situation, and the like. This early awareness allows external expert responders to plan for their arrival, and also to effect positive outcomes even before arrival.

Integration of sensor data may in one embodiment be extended to cooperative buildings near the building where an incident has occurred, to facilities management within the building, to external utilities, and the like.

Ceding control of a building's systems and controls is not to be taken lightly. Security is a concern with such ceding of control. Accordingly, in one embodiment, a security and authentication protocol, such as multi-factor authentication, is used in order to be sure that authorized external responders are in fact the ones requesting the data and/or ceding of control of building/location systems.

Sensors deployed throughout a building or location, in combination with alarm systems, utilities, and the like, allow for occupant notifications of conditions and situations within the building, in addition to notification of issues to building maintenance, facilities management, and external responders. For example, if a fire condition is detected in one part of a building, a system controller that is privy to all sensor information for the building or location can use lighting and alarm prompts to direct occupants to a safe egress location from the building or location.

Sensor data and packages are in one embodiment provided to various responders in layers. For example, upon a first contact with a traditional first responder such as a 911 dispatcher, a full core data set may be provided. This may include by way of example only and not by way of limitation, sensor states pre-incident and at current time, an occupant and/or visitor list for the building/location, building plans, utility status, and the like. Different layers with differing amounts of data may be provided as subsets or on request. For example, subsets of data may be automatically dispatched or made available to appropriate responders, such as a fire package to firefighters for a fire incident, and the like. Also, filtering is provided in one embodiment, so that a responder or receiver of a data pack may filter on specific data as the responder sees fit. Subset data packages may be delivered automatically based on predefined sets of protocols, or may be tailored by a data responder or other emergency responder to get the data that the responder determines is needed. Further subsets of data and their distribution will be evident to those of skill in the art, and are within the scope of the present disclosure.

A VR or AR framework may be provided to inbound responders, allowing them to perform a virtual walkthrough of a building or location prior to arrival. This allows for planning of action that may be commenced immediately upon physical arrival.

In one embodiment, sensors may be expanded to the use of so-called sensor packages within, for example, personal electronic devices of occupants of a building, and to televisions and the like within the building. With a defined emergency protocol, in one embodiment it is possible for external responders to use occupants' personal electronic devices in an emergency mode to communicate with occupants. Smart devices may be activated in this emergency mode to guide and direct occupants and their actions. For example, cellular telephones within a building may receive, through an emergency broadcast message similar in one embodiment to a targeted alert such as an Amber Alert, emergency messages from inbound or on-site responders.

A system in another embodiment comprises a fire suppression system, a lighting system, and an environmental system. The fire suppression system, the lighting system, and the environmental system are each interconnected. A plurality of sensors for each of the systems records data regarding the systems and conditions within the system, and the data is presentable as a current snapshot of the system.

The system is configured in one embodiment to collect and store data from the sensors and from the interconnected systems, and is further configured to present data as a past portrait of system conditions over time.

The system in one embodiment further comprises a controller coupled to the sensors, the fire suppression system, the lighting system, and the environmental system. The controller is configured to collect and store sensor data, and is configured to provide a data packet comprising a set or a subset of the data to an emergency responder upon an authenticated request, or upon an emergency protocol. The interconnected systems and the sensors are coupled to the controller via a power over Ethernet connection in one embodiment.

FIG. 7 shows a representative system that may be connected to and/or used to control embodiments of the present disclosure or a controller for those embodiments. The system 1000 described herein is usable on all the embodiments herein described, and may comprise a digital and/or analog computer. FIG. 10 and the related discussion provide a brief, general description of a suitable computing environment in which the controller can be implemented. Although not required, the controller can be implemented at least in part, in the general context of computer-executable instructions, such as program modules, being executed by a computer 370 which may be connected in wired or wireless fashion to the controller. Generally, program modules include routine programs, objects, components, data structures, etc., which perform particular tasks or implement particular abstract data types. Those skilled in the art can implement the description herein as computer-executable instructions storable on a computer readable medium. Moreover, those skilled in the art will appreciate that the invention may be practiced with other computer system configurations, including multi-processor systems, networked personal computers, mini computers, main frame computers, and the like. Aspects of the invention may also be practiced in distributed computing environments where tasks are performed by remote processing devices that are linked through a communications network. In a distributed computer environment, program modules may be located in both local and remote memory storage devices.

The computer 370 comprises a conventional computer having a central processing unit (CPU) 372, memory 374 and a system bus 376, which couples various system components, including memory 374 to the CPU 372. The system bus 376 may be any of several types of bus structures including a memory bus or a memory controller, a peripheral bus, and a local bus using any of a variety of bus architectures. The memory 374 includes read only memory (ROM) and random access memory (RAM). A basic input/output (BIOS) containing the basic routine that helps to transfer information between elements within the computer 370, such as during start-up, is stored in ROM. Storage devices 378, such as a hard disk, a floppy disk drive, an optical disk drive, etc., are coupled to the system bus 376 and are used for storage of programs and data. It should be appreciated by those skilled in the art that other types of computer readable media that are accessible by a computer, such as magnetic cassettes, flash memory cards, digital video disks, random access memories, read only memories, and the like, may also be used as storage devices. Commonly, programs are loaded into memory 374 from at least one of the storage devices 378 with or without accompanying data.

Input devices such as a keyboard 380 and/or pointing device (e.g. mouse, joystick(s)) 382, virtual controller such as a virtual reality (VR) set or an augmented reality (AR) set, or the like, allow the user to provide commands to the computer 370. A monitor 384 or other type of output device can be further connected to the system bus 376 via a suitable interface and can provide feedback to the user. If the monitor 384 is a touch screen, the pointing device 382 can be incorporated therewith. The monitor 384 and input pointing device 382 such as mouse together with corresponding software drivers can form a graphical user interface (GUI) 386 for computer 370. Interfaces 388 on the system controller 300 allow communication to other computer systems if necessary. Interfaces 388 also represent circuitry used to send signals to or receive signals from the actuators and/or sensing devices mentioned above. Commonly, such circuitry comprises digital-to-analog (D/A) and analog-to-digital (A/D) converters as is well known in the art.

In one embodiment, the controller is coupled to the sensors, and to building operating systems such as but not limited to a fire suppression system, a lighting system, and an environmental system. In one embodiment, the controller is configured to collect and store sensor data from building and system sensors, including but not limited to sensors within the various building operating systems, temperature sensors, air flow sensors, HVAC sensors, occupancy sensors, and the like. Further, the controller is in one embodiment configured to provide the previously discussed data packet or subsets of data to a first responder such as but not limited to a data responder, an onsite responder, an emergency responder or the like. Such data packets may be distributed to an emergency responder upon an authenticated request, or automatically based on a predefine set of protocols or criteria.

Although the present disclosure has been described with reference to preferred embodiments, workers skilled in the art will recognize that changes may be made in form and detail without departing from the spirit and scope of the disclosure.

What is claimed is:

1. A coordinated system for a location, comprising:
a plurality of sensors arrayed within the location to monitor and record location conditions;
at least one building operation subsystem; and
a controller coupled to the plurality of sensors and to the at least one building operation subsystem, the controller configured to:
collect data from the at least one building operation subsystem;
collect data from the plurality of sensors; and
generate a building information data packet comprising the collected data.

2. The system of claim 1, wherein the controller is further configured to generate a set of building plans in three dimensions overlaid with collected data.

3. The system of claim 1, wherein the controller is further configured to:
provide a building information data packet to a first responder upon a triggering event.

4. The system of claim 3, wherein the controller is further configured to:
cede control of the plurality of interconnected location subsystems to the first responder upon an authenticated request for building control.

5. The system of claim 4, wherein the controller is further configured to provide real-time sensor data overlaid with building plans to an offsite viewing device.

6. The system of claim 5, wherein the controller is further configured to provide real-time sensor data overlaid with building plans by providing to at least one of a virtual reality set, an augmented reality set, or a heads up display.

7. The system of claim 4, wherein the controller is further configured to provide predefined subset building information packets to specific first responders based on a set of protocols for such provision.

8. The system of claim 1, wherein the at least one building operation subsystem and the sensors are coupled to the controller via a power over Ethernet connection.

9. The system of claim 1, wherein the plurality of sensors comprises at least one of temperature sensors, occupancy sensors, emergency sensors, and HVAC sensors.

10. The system of claim 1, wherein the at least one building operation subsystem comprises a plurality of interconnected building operation subsystems for lighting, HVAC, and emergency response.

11. The system of claim 1, wherein the controller is further configured to validate data from a sensor of the plurality of sensors.

12. The system of claim 1, wherein the at least one building operation subsystem is a lighting system, and wherein the controller is further configured to provide lighting data viewable with a set of transport controls including rewind, pause, and fast forward.

13. The system of claim 12, wherein the controller is further configured to predict lighting patterns for spaces within the location based on previous lighting patterns for the spaces.

14. The system of claim 1, wherein the at least one building operation subsystem is an HVAC system, and wherein the controller is further configured to provide HVAC data viewable with a set of transport controls including rewind, pause, and fast forward.

15. The system of claim 14, wherein the controller is further configured to predict HVAC patterns for spaces within the location based on previous HVAC patterns for the spaces.

16. The system of claim 1, wherein the plurality of sensors comprises at least one of temperature sensors, occupancy sensors, emergency sensors, and HVAC sensors, and wherein the controller is further configured to provide sensor data viewable with a set of transport controls including rewind, pause, and fast forward.

17. The system of claim 16, wherein the controller is further configured to predict data patterns for spaces within the location based on previous data patterns for the spaces.

18. An emergency response method for a building, comprising:
collecting data from a plurality of interconnected building systems;
collecting data from a plurality of building sensors; and
generating a building information data packet comprising the collected data and a set of building plans in three dimensions.

19. The method of claim 18, wherein collecting data from a plurality of building sensors comprises collecting data from at least one of temperature sensors, occupancy sensors, emergency sensors, HVAC sensors.

20. The method of claim 18, wherein collecting data from a plurality of interconnected building systems comprises collecting data from at least one of interconnected subsystems for lighting, HVAC, and emergency response.

21. The method of claim 19, and further comprising validating data from a sensor of the plurality of sensors.

22. The method of claim 18, wherein a controller is configured to collect data from the plurality of interconnected building systems and from the plurality of building sensors.

23. The method of claim 22, wherein the controller is further configured to:
provide the building information data packet to a first responder upon a triggering event; and
cede control of the plurality of interconnected location subsystems to the first responder upon an authenticated request for building control.

24. The method of claim 23, and further comprising providing real-time sensor data overlaid with building plans to an offsite viewing device.

25. The method of claim 24, wherein providing real-time sensor data overlaid with building plans comprises providing to a virtual reality set, an augmented reality set, or a heads up display.

26. The method of claim 23, wherein the controller is further configured to provide predefined subset building information packets to specific first responders based on a set of protocols for such provision.
